(19) United States
(12) Patent Application Publication
(10) Pub. No.: US 2014/0062039 A1
(43) Pub. Date: Mar. 6, 2014

(54) QUICK-CHANGE TOP TOOLING

(71) Applicant: Positrol Inc., Cincinnati, OH (US)

(72) Inventors: Joshua Pocock, Cincinnati, OH (US); William Voet, Butler, KY (US)

(73) Assignee: Positrol Inc., Cincinnati, OH (US)

(21) Appl. No.: 14/017,346

(22) Filed: Sep. 4, 2013

Related U.S. Application Data
(60) Provisional application No. 61/696,854, filed on Sep. 5, 2012.

(51) Int. Cl. B23B 31/10

(52) U.S. Cl. CPC B23B 31/102
USPC 279/133; 279/152

(57) ABSTRACT

A quick-change top tooling system is provided to accommodate various sized and configurations of workpieces to be chucked. The quick-change top tooling system includes a chuck body, at least one jaw assembly, and at least one workstop assembly. The jaw assembly comprises a master post fixed to a surface of the chuck body and a jaw releasably coupled to the master post. The workstop assembly comprises a workstop base mounted to the surface of the chuck body and a workstop releasably coupled to the workstop base. The at least one jaw and workstop may engage and clamp a workpiece to be chucked to maintain the concentricity and parallelism of the workpiece.

### PRIORITY

The present application claims the benefit of U.S. Provisional App. No. 61/696,854, entitled “Quick-Change Top Tooling,” filed on Sep. 5, 2012, the disclosure of which is hereby incorporated by reference in its entirety.

### BACKGROUND

Quick-change top tooling may be typically used in chucks for rotary machine tools and may include jaw assemblies and workstop assemblies to clamp and hold a workpiece. Chucks having quick-change top tooling may be well suited for use in repetitive small batch production operations where frequent changeover may be required, or where changeover time may be significant. At the end of each production run, it may be necessary to remove the jaws and workstops from the chuck and replace them with another set of top tooling adapted to accommodate the next workpiece, which may be of a substantially different size or configuration. Precise concentricity of the jaws and parallelism of the workstop may be maintained to achieve close tolerance workholding. Desired close tolerances may be maintained by remachining the jaws and workstop after each changeover. However, remachining processes are costly and time consuming.

As an alternative to remachining, quick-change top tooling has been available to provide interchangeability among quick-change jaws and workstops that may still maintain concentricity and parallelism. However, such quick-change systems generally employ a complex mounting mechanism and are usually costly to produce. The quick-change systems also often require special tools for changing over their top tooling. Thus, it may be desirable to provide an improved interchangeable quick-change top tooling system that may be changed without the use of any additional tooling or remachining.

While several devices and methods have been made and used for providing quick-change top tooling, it is believed that no one prior to the inventors have made or used the invention described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a perspective view of an exemplary quick-change top tooling system;

FIG. 2 depicts a front elevation view of the quick-change top tooling system of FIG. 1;

FIG. 3 depicts a side elevation view of the quick-change top tooling system of FIG. 1 taken along line 3-3 of FIG. 2;

FIG. 4 depicts a front elevation view of the chuck body of FIG. 1;

FIG. 5 depicts a sectional view of the quick-change jaw of FIG. 1;

FIG. 6 depicts a sectional view of the master post of FIG. 1;

FIG. 7 depicts a side view of the master post of FIG. 1;

FIG. 8 depicts a sectional view of another exemplary quick-change jaw;

FIG. 9 depicts a sectional view of another exemplary master post;

FIG. 10 depicts a side view of the master post of FIG. 9;

FIG. 11 depicts a sectional view the quick-change jaw assembly of FIG. 1;

FIG. 12 depicts a side view of the plunger of FIG. 1;

FIG. 13 depicts a sectional view of another exemplary quick-change jaw assembly;

FIG. 14 depicts a sectional view of the workstop base of FIG. 1;

FIG. 15 depicts a sectional view of the quick-change workstop of FIG. 1; and

FIG. 16 depicts a sectional view of the quick-change workstop assembly of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to one skilled in the art from the following description. As will be realized, the invention is capable of other different and obvious aspects, all without departing from the invention. Accordingly, the drawings and descriptions should be regarded as illustrative in nature and not restrictive.

### I. Exemplary Quick-Change Top Tooling System

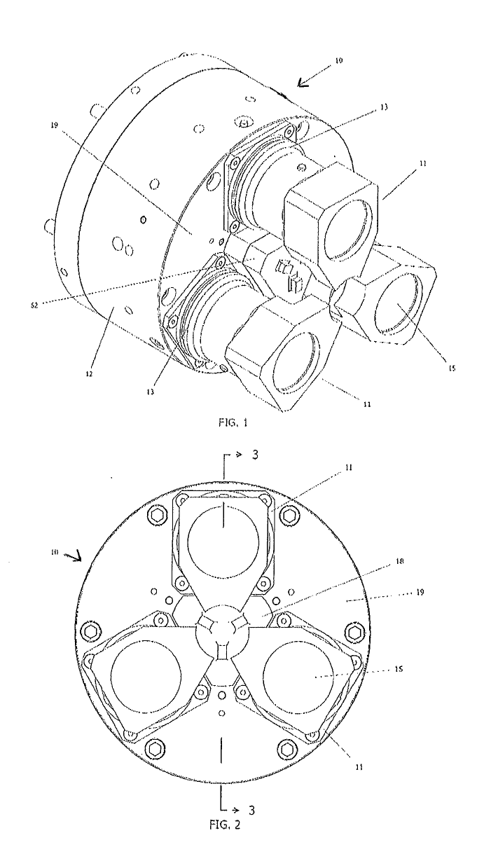

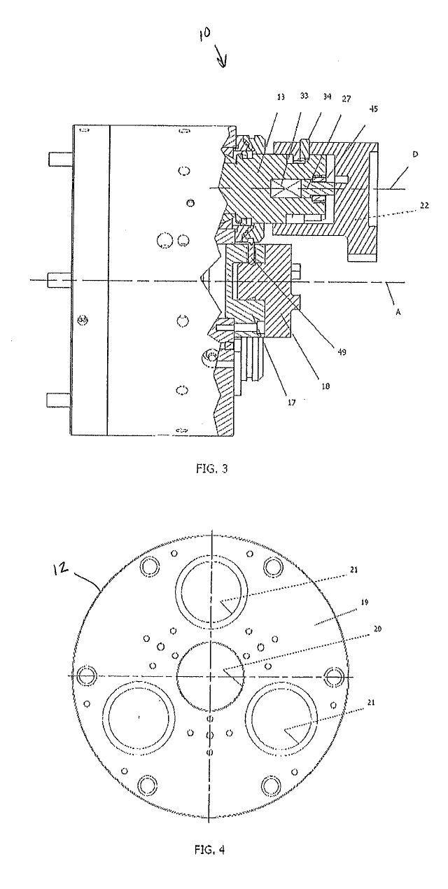

An exemplary quick-change top tooling system (10) is shown in FIGS. 1-3. Top tooling system (10) comprises a chuck body (12), at least one quick-change jaw assembly (11), and at least one quick-change workstop assembly (52). Jaw assembly (11) may be mounted on a surface (19) of chuck body (12). FIGS. 1 and 2 depict three jaw assemblies (11) mounted on chuck body (12); however, the amount of jaw assemblies (11) used in top tooling assembly (10) may vary as will be apparent to one with ordinary skill in the art in view of the teachings herein. Jaw assemblies (11) may be positioned concentrically on chuck body (12) about a longitudinal axis A defined by chuck body (12). Workstop assembly (52) may also be mounted on surface (19) of chuck body (12). Workstop assembly (52) may be coaxial with chuck body (12) and parallel to surface (19) on chuck body (12). The amount of workstop assemblies (52) used in top tooling assembly (10) may also vary as will be apparent to one with ordinary skill in the art in view of the teachings herein.

Top tooling system (10) may be suitable for use in any machine tool that requires a rotary or a stationary chuck. Top tooling system (10) may be adapted for use in a high production machine tool and may be arranged to clamp and hold a workpiece (not shown) to be chucked. Jaw assemblies (11) and workstop assembly (52) may engage the workpiece such that top tooling system (10) may be configured to clamp and hold the workpiece between jaw assemblies (11) and workstop assembly (52). Top tooling system (10) may clamp and hold the workpiece by either an outside diameter, an inside diameter, or a face of the workpiece. Other suitable configurations to clamp and hold a workpiece will be apparent to one with ordinary skill in the art in view of the teachings herein. As shown in FIGS. 1-3, top tooling system (10) may be configured for holding the outside diameter of the workpiece. Top tooling system (10) may be power, manual, spring, hydraulic, or pneumatically operated. Other suitable operating methods for operating top tooling system (10) will be apparent to one with ordinary skill in the art in view of the teachings herein.

### A. Exemplary Chuck Body

As shown in FIGS. 1-4, chuck body (12) may be a cylindrical body comprising an exterior surface (19) on an end of chuck body (12) positioned toward a workpiece to be chucked. Exterior surface (19) may be substantially flat such that exterior surface (19) is substantially perpendicular to longitudinal axis A. Although FIGS. 1-4 depict chuck body (12) to be cylindrical, the shape of chuck body (12) and exterior surface (19) may vary (e.g., triangular, square, trapezoidal, etc.). Chuck body (12) comprises jaw assembly openings (21) and a workstop assembly opening (20), as shown in FIG. 4. Each jaw assembly opening (21) may be concentrically spaced about longitudinal axis A and configured to receive a jaw assembly (11). Jaw assembly openings (21) may also be equiangularly spaced around exterior surface (19). Although FIG. 4 shows each jaw assembly opening (21) spaced equidistantly and equiangularly about longitudinal axis A, it should be noted that each jaw assembly opening (21) may be spaced at different distances and/or angles about longitudinal axis A from other jaw assembly openings (21). The amount of jaw assembly openings (21) may correspond to the desired amount of jaw assemblies (11) that may be mounted on chuck body (12), which may vary as will be apparent to one with ordinary skill in the art in view of the teachings herein. Workstop assembly opening (20) may be coaxially positioned with chuck body (12) and configured to receive a workstop assembly (52). Jaw assembly openings (21) and workstop assembly opening (20) may be substantially parallel to longitudinal axis A and may extend through a portion or the entire length of chuck body (12) such that each opening (20, 21) may communicate with an interior of chuck body (12). Chuck body (12) may also be configured to rotate about longitudinal axis A.

Chuck body (12) may be hollow and contain a jaw actuating device (not shown). The jaw actuating device contained within chuck body (12) may operate top tooling system (10) to simultaneously move jaw assemblies (11), with compensation. Jaw assemblies (11) may move in a radial direction either towards or away from longitudinal axis A while also moving slightly towards and away from exterior surface (19), along an axis at a set angle from axis A, or directly toward exterior surface (19) along an axis parallel to axis A while in rotation for a portion of the cycle. Other suitable movements of jaw assemblies (11) will be apparent to one with ordinary skill in the art in view of the teachings herein. Such movement of jaw assemblies (11) may clamp and hold a workpiece. The jaw actuating device may be manually or power operated (e.g., hydraulically, pneumatically, etc.).

### B. Exemplary Quick-Change Jaw Assembly

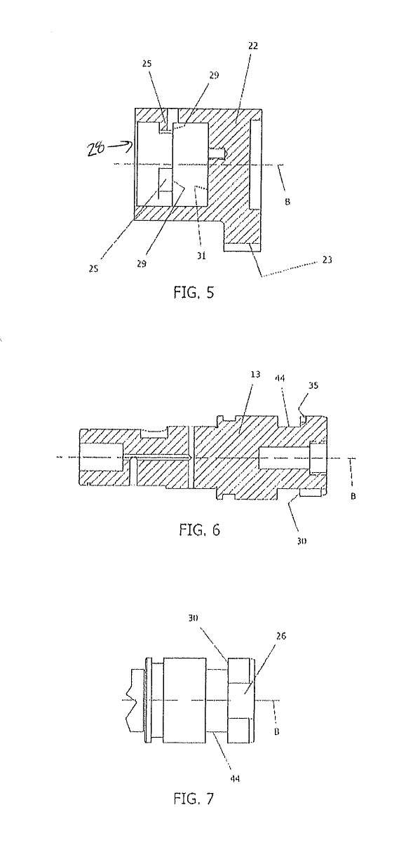

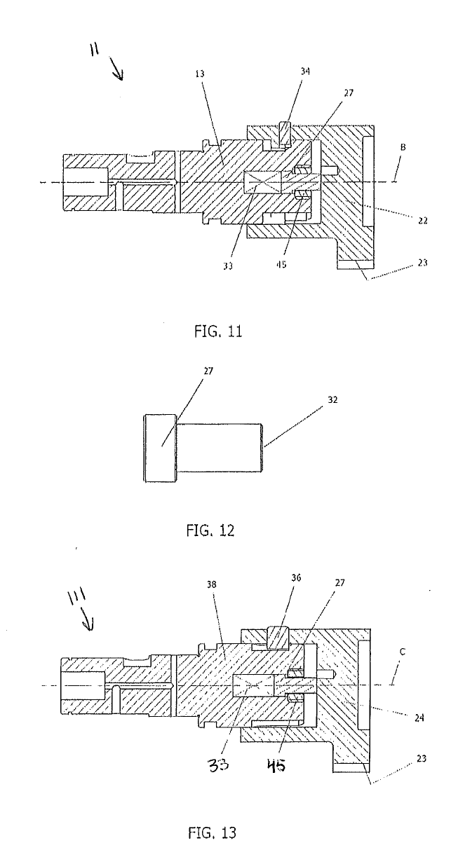

An exemplary quick-change jaw assembly (11) is shown in FIGS. 5-7 and 11-12. A jaw assembly (11) comprises a master post (13) and a jaw (22). Master post (13) may be coupled to exterior surface (19) by inserting master post (13) into jaw assembly opening (21) such that master post (13) may be supported by chuck body (12). Each quick-change jaw (22) may be releasably received and supported on a master post (13) without the loss of chucking concentricity or rigidity. Jaws (22) may be configured for a variety of clamping motions: radial movement toward and away from longitudinal axis A while also moving towards and away from exterior surface (19); along an axis at a set angle from longitudinal axis A; or directly towards exterior surface (19) parallel to longitudinal axis A while in rotation for a portion of the cycle. Other suitable movements of jaw assemblies (11) will be apparent to one with ordinary skill in the art in view of the teachings herein. Such movement of jaw assemblies (11) may clamp and hold a workpiece to maintain concentricity of the workpiece. When top tooling system (10) is operated to move jaws (22) towards the workpiece for clamping, forces applied to top tooling system (10) to clamp the workpiece also act to provide reactive forces for urging jaws (22) and master posts (13) into coengagement with each other when jaws (22) are brought into clamping engagement with the workpiece.

Jaw (22) may be configured as an elongated square block comprising an inner cavity (28) such that the inner cavity (28) may releasably engage master post (13) to interchangeably mount jaw (22) onto master post (13). Other suitable jaw (22) configurations may be used (e.g., rectangle, circle, triangle, trapezoid, etc.). Inner cavity (28) may comprise a cavity surface (31) positioned toward master post (13) and substantially perpendicular to longitudinal axis B defined by jaw assembly (11). Jaw (22) comprises protrusions (25) extending into inner cavity (28) toward a longitudinal axis B to a common diameter. Protrusions (25) comprise a protrusion surface (29). Jaw (22) further comprises a clamping surface (23) on a radially inner end for engaging the workpiece to be chucked. Clamping surface (23) may comprise various lengths and surface configurations to accommodate the size and/or configuration of the workpiece. A pin (34) fixed to jaw (22) at a position along longitudinal axis B and radially oriented relative to clamping surface (23) may maintain radial alignment between jaw (22) and master post (13).

Master post (13) comprises a substantially cylindrical body (32) and a clearance groove (44) to releasably couple with jaw (22). Master post (13) further comprises one or more slots (26) extending from an end configured to engage a jaw (22) to clearance groove (44), which is concentric to and positioned along axis B to allow for assembly. Clearance groove (44) provides a protrusion engaging surface (30) on a wall of clearance groove (44) facing away from jaw (22) and substantially perpendicular to longitudinal axis B. A wall of clearance groove (44) also comprises a notch (35) for engaging pin (34). Notch (35) may comprise an arcuate surface to correspond to the shape of pin (34). A plunger (27) may be contained within an inner cavity (28) in master post (13) and held in position by a set screw (45). A resilient member (33) may be positioned in inner cavity (28) to resiliently bias plunger (27) away from inner cavity (28). Plunger (27) comprises a top surface (32) that may engage cavity surface (31) of jaw (22).

When jaw (22) is releasably coupled to master post (13), top surface (32) on plunger (27) may push against cavity surface (31) on jaw (22) along longitudinal axis B. As resilient member (33) pushes plunger (27), the top of protrusion surface (29) on jaw (22) pushes against the corresponding protrusion engaging surface (30) on master post (13). These forces hold jaw (22) axially in place relative to master post (13). Pin (34) of jaw (22) may nest inside of notch (35) on master post (13) to rotationally hold jaw (22) in place relative to master post (13).

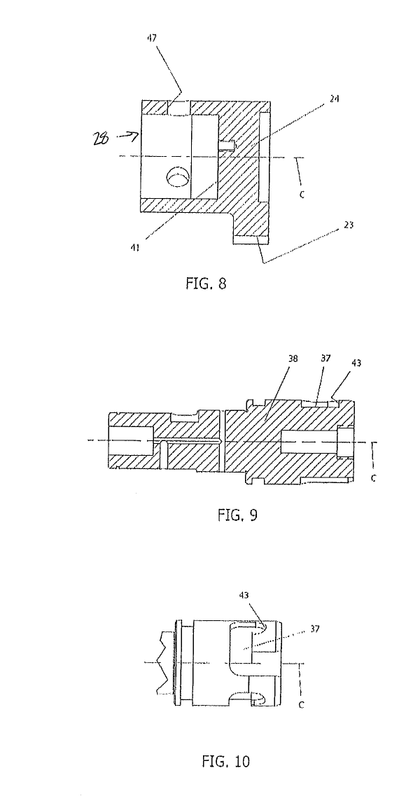

Another example of a quick-change jaw assembly (111) is shown in FIGS. 8-10 and 12-13. Jaw assembly (111) is similar to jaw assembly (11) described above. Jaw assembly (111) comprises a jaw (24) and a master post (38). Jaw (24) is configured similarly to jaw (22) except that jaw (24) of jaw assembly (111) comprises one or more pins (36) that are fixed to jaw (24) and project into inner cavity (28) toward a longitudinal axis C, defined by jaw assembly (111), to a common diameter at a location along axis C in relation to clamping surface (23). Master post (38) of jaw assembly (111) is similar to master post (13) except that master post (38) comprises one or more slots (37) to correspond to pins (36) formed to a specific depth to allow for assembly. Slots (37) extend through master post (38) away from an end that is configured to engage jaw (24) and then extend circumferentially around master post (38). A notch (43) may be provided at the end of slot (37) to protrude axially on master post (38) (FIG. 10).

When jaw (24) is coupled to master post (38), resilient member (33) pushes plunger (27) outward from inner cavity (28). Top surface (32) on plunger (27), contained in master post (38) by set screw (45), then pushes against cavity surface (31) on jaw (24) along longitudinal axis C. This holds jaw (24) axially in place relative to master post (38). Resilient member (33) also pushes plunger (27) outward from inner cavity (33) to force pins (36) on jaw (24) against corresponding notches (43) on slots (37) to maintain a radial relationship between jaw (24) and master post (38).

### C. Exemplary Quick-Change Workstop Assembly

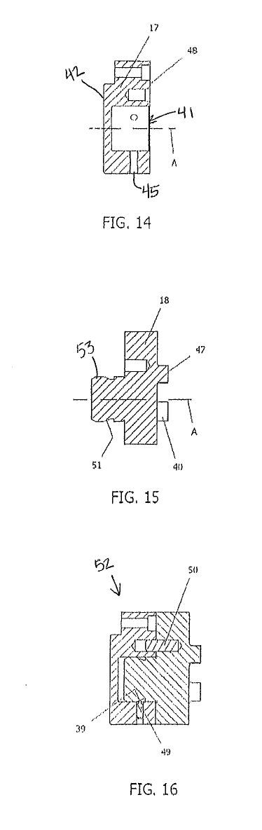

An exemplary workstop assembly (52) is shown in FIGS. 14-16. Workstop assembly (52) comprises a base (17) and a workstop (18). Workstop base (17) may be coaxially fixed to chuck body (12) along longitudinal axis A. Base (17) may comprise a triangular block, however other suitable base (17) configurations may be used (e.g., circular, rectangular, square, trapezoidal). Base (17) may comprise a face (48) that is substantially flat and parallel to exterior surface (19) on chuck body (12). Base (17) may further comprise a protrusion (42) that corresponds to workstop assembly opening (20) in chuck body (12). Protrusion (42) may be inserted into workstop opening (20) to be supported by chuck body (12). Base (17) may be fixed to chuck body (12) by a screw or other fastener through opening (43) on base (17). Base (17) further comprises an inner cavity (41) extending into base (17) coaxially with longitudinal axis (A) to releasably receive workstop (18) without the loss of parallelism or rigidity Inner cavity (41) may comprise a slot (45) that is substantially perpendicular to inner cavity (41) and extends from inner cavity (41) through an exterior wall of base (17).

Workstop (18) comprises a triangular block to correspond to base (17), however other suitable workstop (18) configurations may be used (e.g., circular, rectangular, square, trapezoidal). Workstop (18) comprises one or more protrusions (40) having a locating surface (47) which may be flat to maintain parallelism with exterior surface (19) on chuck body (12). Protrusions (40) extend from workstop (18) such that locating surfaces (47) may engage a workpiece to allow for better workpiece positioning, easier evacuation of debris generated during machining, and easier loading/unloading of workstop. Although three protrusions (40) are shown, the amount of protrusions may vary as will be apparent to one with ordinary skill in the art in view of the teachings herein. Workstop (18) also comprises a protrusion (53) extending outward from workstop (18) that is configured to releasably engage inner cavity (41) of base (17) and hold concentricity of chuck body (12). Base engaging feature (53) further comprises a whistle notch comprising an angular surface (51). The notch may align with slot (45) of base (17) at a predetermined position along longitudinal axis A to provide a means to retain workstop (18) onto base (17) and maintain concentricity.

When workstop (18) is coupled to base (17), one or more resiliently biased plungers (49) may be inserted into base (17) through slot (45) and positioned radially along longitudinal axis A at a predetermined distance. Plunger (49) may comprise a tangential surface (39) to engage angular surface (51) on the notch on workstop (18). This may maintain an axial position between workstop (18) and base (17). The quantity and distance of plungers (49) may have a direct impact on the amount of force applied on angular surface (51) on workstop (18). A pin (50) may be fixed to workstop (18) on a predetermined radius to engage a cutout on base (17) on the predetermined radius to ensure radial orientation of workstop (18) relative to base (17).

### II. Exemplary Method

Top tooling system (10) comprises interchangeable jaws (22, 24) and workstops (18) that may be changed without the use of any additional tooling or remachining to accommodate different configurations of workpieces to be chucked. A chuck body (12) may be provided with exterior surface (19) facing the workpiece. Master posts (13, 38) may be provided within jaw assembly openings (21) of chuck body (12) and fixed to exterior surface (19) of chuck body (12). Workstop base (17) may be provided within workstop assembly opening (20) of chuck body (12) and fixed to exterior surface (19) of chuck body (12).

Workstop (18) may be releasably coupled to base (17). Workstop (18) may be coaxially aligned with base (17) such that protrusion (53) on workstop (18) is aligned with inner cavity (41) on base (17). Protrusion (53) may be inserted within inner cavity (41) until angular surface (51) on protrusion (53) is axially aligned with slot (45) of inner cavity (41). A resiliently biased plunger (49) may then move upward within slot (45) such that surface (39) of plunger (49) engages angular surface (51) of protrusion (53). The resilient force against plunger (49) toward protrusion (53) may hold workstop (18) axially in place relative to base (17). Pin (50) of workstop (18) further engages an opening in base (17) to rotationally hold workstop (18) in place relative to base (17) when protrusion (53) of workstop (18) is positioned within inner cavity (41) of base (17).

Jaws (22, 24) may be releasably coupled to master posts (13, 38). Jaw (22, 24) may be positioned such that inner cavity (28) of jaw (22, 24) aligns with the body of master post (13, 38) such that pins (34, 36) on jaw (22, 24) correspond to slots (26, 37) on master post (13, 38). As jaw (22, 24) slides over master post (13, 38), pins (34, 36) on jaw (22, 24) slide through slots (27, 37) on master post (13, 38). Jaw (22, 24) slides over master post (13, 38) until pins (34, 36) have reached clearance groove (44) or a back wall of slot (37). When jaw (22, 24) is loaded onto master post (13, 38), resilient member (33) may be depressed. Jaw (22, 24) may then rotate about longitudinal axis B or C such that pins (34) rotate about clearance groove (44) or pins (36) rotate within slot (37). Once in this position, jaw (22, 24) may be released, allowing resilient (33) member to push jaw (22, 24) into position on master post (13, 38).

When jaw (22) is releasably coupled to master post (13), top surface (32) on plunger (27) may push against cavity surface (31) on jaw (22) along longitudinal axis B. As resilient member (33) pushes plunger (27), the top of protrusion surface (29) on jaw (22) is pushed against the corresponding protrusion engaging surface (30) on master post (13). These forces hold jaw (22) axially in place relative to master post (13). Pin (34) of jaw (22) then nests inside of notch (35) on master post (13) to rotationally hold jaw (22) in place relative to master post (13).

When jaw (24) is coupled to master post (38), resilient member (33) pushes plunger (27) outward from inner cavity (33). Top surface (32) on plunger (27), contained in master post (38) by set screw (45), then pushes against cavity surface (31) on jaw (24) along longitudinal axis C. This holds jaw (24) axially in place relative to master post (38). Resilient member (33) also pushes plunger (27) outward from inner cavity (28) to force pins (36) on jaw (24) against corresponding notches (43) on slots (37) to maintain a radial relationship between jaw (24) and master post (38).

Once workstop assembly (52) and jaw assemblies (11, 111) are positioned, top tooling system (10) may receive a workpiece to be chucked. The workpiece may be inserted into top tooling system such that the workpiece contacts workstop (18). Workstop (18) maintains the parallelism between the workpiece and chuck body (12). Jaw assemblies (11, 111) may move to clamp and hold the workpiece. A jaw actuating device contained within chuck body (12) may operate top tooling system (10) to simultaneously move jaw assemblies (11, 111), with compensation. Jaw assemblies (11, 111) may be moved in a radial direction either towards or away from longitudinal axis A while also moving slightly towards and away from exterior surface (19), along an axis at a set angle from axis A, or directly toward exterior surface (19) along an axis parallel to axis A while in rotation for a portion of the cycle. Other suitable movements of jaw assemblies (11, 111) will be apparent to one with ordinary skill in the art in view of the teachings herein. Such movement of jaw assemblies (11, 111) may clamp and hold a workpiece via clamping surfaces (23) on jaws (22, 24). The jaw actuating device may be manually or power operated (e.g., hydraulically, pneumatically, etc.). Jaw assemblies (11, 111) may maintain concentricity of the workpiece.

The workpiece may be chucked while it is held within top tooling system (10). Afterwards, jaw assemblies (11, 111) may be moved back to their original position by the jaw actuating device to release the workpiece. The workpiece may be removed from top tooling system (10). Because it may be desirable to chuck another workpiece having a different size or configuration, jaws (22, 24) and/or workstop (18) may be interchanged to accommodate the next workpiece. Jaws (22, 24) and workstop (18) may be interchanged without the need for additional tools or remachining.

Jaws (22, 24) may be removed from master post (13, 38). Jaws (22, 24) may be grasped and depressed onto master post (13, 38) to depress the resilient member (33). This releases pins (34, 36) into clearance groove (44) or slot (37). Jaw (22, 24) may be rotated in the opposite direction to align pins (34, 36) with the openings of slots (26, 37). Jaws (22, 24) may be slid off of master post (13, 38) such that pins (34, 36) slide through slots (26, 37). Jaws (22, 24) may then be removed from master post (13, 38).

Workstop (18) may be removed from base (17). When workstop (18) is pulled away from base (17), resilient plunger (49) may depress in slot (45) away from angular surface (51) of workstop (18). This allows workstop (18) to be removed from base (17).

Various jaws (22, 24) and workstops (18) may be interchanged on jaw assemblies (11, 111) and workstop assemblies (52) to provide jaws (22, 24) and workstops (18) with different sizes and configurations to accommodate different workpieces. The next jaw (22, 24) and/or workpiece (18) may be loaded onto top tooling system (10) as described above, without additional tooling or remachining Additionally, jaws (22, 24) and workstops (18) may be interchanged manually, or by a robot. For instance, a robot may mimic the manual movements described above to interchange jaws (22, 24) and/or workstop (18).

Having shown and described various embodiments of the invention disclosed herein, further adaptations of the methods and systems described herein may be accomplished by appropriate modification by one of ordinary skill in the art without departing from the scope of the invention disclosed herein. Several of such potential modifications have been mentioned, and others will be apparent to those skilled in the art. For instance, examples, embodiments, geometrics, materials, dimensions, ratios, steps, and the like discussed above are illustrative. Accordingly, the scope of the present invention should be considered in terms of the following claims and is understood not to be limited to the details of structure and operation shown and described in the specification and drawings.

I/we claim:

1. A top tooling apparatus comprising:
(a) a body comprising an exterior surface;
(b) a jaw assembly comprising:
(i) a master post coupled with the body such that the master post extends outwardly from the exterior surface of the body, and
(ii) a jaw releasably coupled with the master post; and
(c) a workstop assembly comprising:
(i) a base coupled with the body such that the base extends outwardly from the exterior surface of the body, and
(ii) a workstop releasably coupled with the base.

2. The apparatus of claim 1, wherein the body comprises a plurality of openings positioned on the exterior surface.

3. The apparatus of claim 2, wherein a select opening of the plurality of openings is configured to receive the master post.

4. The apparatus of claim 3, wherein the plurality of openings are equiangularly spaced around the exterior surface.

5. The apparatus of claim 2, wherein a select opening of the plurality of openings is configured to receive the base.

6. The apparatus of claim 1, wherein the jaw assembly is translatable relative to the body.

7. The apparatus of claim 1, wherein the jaw assembly is rotatable relative to the body.

8. The apparatus of claim 1, wherein the jaw comprises a clamping surface configured to engage a workpiece to maintain the concentricity of the workpiece.

9. The apparatus of claim 1, wherein the jaw comprises an inner cavity and a protrusion extending within the inner cavity, wherein the master post comprises a slot configured to receive the protrusion to maintain the axial position of the jaw relative to the master post.

10. The apparatus of claim 9, wherein the jaw assembly comprises a resilient member configured to bias the protrusion of the jaw against a wall in the slot of the master post.

11. The apparatus of claim 9, wherein the jaw comprises a pin, wherein the master post comprises a notch configured to receive the pin of the jaw to maintain the radial position of the jaw relative to the master post.

12. The apparatus of claim 1, wherein the jaw comprises an inner cavity and a pin extending within the inner cavity, wherein the master post comprises a slot extending inwardly and circumferentially around the master post, wherein the slot comprises a notch, wherein the notch of the slot is configured to receive the pin to maintain the radial position of the jaw relative to the master post.

13. The apparatus of claim 12 further comprising a resilient member configured to bias the pin against the notch.

14. The apparatus of claim 1, wherein the workstop comprises a locating surface configured to engage a workpiece to maintain the parallelism of the workpiece.

15. The apparatus of claim 1, wherein the base comprises an inner cavity configured to receive a portion of the workstop.

16. The apparatus of claim 15, wherein the workstop assembly comprises a plunger, wherein the workstop comprises a notch, wherein the base comprises a slot, wherein the plunger is configured to be inserted through the slot of the base to engage the notch of the workstop to maintain the axial position of the workstop relative to the base.

17. The apparatus of claim 15, wherein the workstop comprises a pin configured to engage a cutout on the base to maintain radial position of the workstop relative to the base.

18. A top tooling apparatus comprising:
(a) a body comprising an exterior surface;
(b) a master post extending outwardly from the exterior surface of the body;
(c) a jaw releasably coupled with an end of the master post, wherein the jaw is configured to engage a workpiece;
(d) a base extending outwardly from the exterior surface of the body; and
(e) a workstop releasably coupled with the base, wherein the workstop is configured to engage the workpiece.

19. A top tooling apparatus comprising:
(a) a body comprising an exterior surface;
(b) a master post extending outwardly from the exterior surface of the body;
(c) a first jaw releasably coupled with the master post; and
(d) a resilient member configured to bias the first jaw against the master post to maintain the position of the first jaw relative to the master post.

20. The apparatus of claim 19, wherein a second jaw is releasably coupled with the master post when the first jaw is removed from the master post.
